(19) United States
(12) Patent Application Publication
(10) Pub. No.: US 2009/0258225 A1
(43) Pub. Date: Oct. 15, 2009

(54) DOUBLE-SIDED PRESSURE-SENSITIVE ADHESIVE SHEET AND PRODUCTION METHOD THEREOF

(75) Inventors: Takuo Nishida, Saitama (JP); Akihito Yamada, Saitama (JP); Sou Miyata, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: LINTEC CORPORATION, Itabashi-ku (JP)

(21) Appl. No.: 12/418,669

(22) Filed: Apr. 6, 2009

(30) Foreign Application Priority Data
Apr. 10, 2008 (JP) 2008-102322

(51) Int. Cl. B32B 7/12; B32B 37/00

(52) U.S. Cl. 428/352; 156/60

(57) ABSTRACT

Provided are a double-sided pressure-sensitive adhesive sheet which is free from an adverse affect on an electronic part or the like and is excellent in releasing performance and a production method thereof. The double-sided pressure-sensitive adhesive sheet includes: a pressure-sensitive adhesive layer; a first release sheet having a first release agent layer adhered to one surface of the pressure-sensitive adhesive layer; and a second release sheet having a second release agent layer adhered to another surface of the pressure-sensitive adhesive layer, in which: the first release agent layer and the second release agent layer are each formed by using a diene-based polymeric compound; when, at ordinary temperatures, a release force of the first release sheet to the pressure-sensitive adhesive layer is represented by X and a release force of the second release sheet to the pressure-sensitive adhesive layer is represented by Y, a relationship of Y−X≧50 is satisfied and Y represents 2,000 or less, where units of X and Y are each mN/20 mm; and the pressure-sensitive adhesive layer, the first release agent layer, and the second release agent layer are each substantially free of a silicone compound, and the production method for the double-sided pressure-sensitive adhesive sheet includes: forming a coating film by coating a top of the second release sheet with a material for forming the pressure-sensitive adhesive layer, the material containing a pressure-sensitive adhesive; forming the pressure-sensitive adhesive layer by drying the coating film; and adhering the first release sheet to a surface of an opposite side of the formed pressure-sensitive adhesive layer to which the second release sheet is adhered.

### BACKGROUND OF THE INVENTION

1. Field of the Invention

The present invention relates to a double-sided pressure-sensitive adhesive sheet and a production method thereof. More specifically, the present invention relates to a double-sided pressure-sensitive adhesive sheet in which a non-silicone-based pressure-sensitive adhesive is used, and which has an appropriate difference between a release force between a first release sheet (first release agent layer) and a pressure-sensitive adhesive layer and a release force between a second release sheet (second release agent layer) and the pressure-sensitive adhesive layer, and is particularly suitably used for electronic parts, and a production method thereof.

2. Description of the Related Art

Electronic parts such as relays, various kinds of switches, connectors, motors, and hard disks are widely used in various products. In those electronic parts, a double-sided pressure-sensitive adhesive sheet is used for the purposes of a temporary joint at the time of assembling, a fixation of a part, a content indication label of a part, and the like. The double-sided pressure-sensitive adhesive sheet is generally formed only of a pressure-sensitive adhesive layer, and release sheets are adhered to both surfaces of the pressure-sensitive adhesive layer before the double-sided pressure-sensitive adhesive sheet is adhered to an electronic part.

On the surface (contact surface with the pressure-sensitive adhesive layer) of the release sheet, a release agent layer is provided for the purpose of improving releasability. Conventionally, a silicone resin has been used for a constituent material of the release agent layer. However, it is known that, when the release sheet is adhered to a pressure-sensitive adhesive sheet, a silicone compound such as a low-molecular-weight silicone resin, siloxane, or silicone oil which is contained in the release sheet is transferred to the pressure-sensitive adhesive layer of the pressure-sensitive adhesive sheet. Therefore, in the case where the pressure-sensitive adhesive sheet which has been adhered to the release sheet is adhered to the electronic part, the silicone compound which has been transferred to the pressure-sensitive adhesive layer gradually vaporizes thereafter. It is said that the vaporized silicone compound is accumulated on the surface of an electric contact point of the electronic part owing to, for example, an arc generated at the vicinity of the electric contact point, and forms a minute silicon oxide compound layer. Thus, when the silicon oxide compound is accumulated on the surface of the electric contact point, conduction failure may occur. Further, particularly when the pressure-sensitive adhesive sheet is adhered to a hard disk device, the silicone compound which has been transferred to the pressure-sensitive adhesive layer gradually vaporizes and accumulates on the surface of a magnetic head or a disk and the like. Those accumulations of the minute silicon oxide compound may have an adverse affect on reading data from and writing data on the hard disk. In order to solve those problems, a development of a release sheet which is formed of a polyolefin-based film and is not subjected to silicone treatment is being attempted (for example, see JP 3886225 B).

However, when a double-sided pressure-sensitive adhesive sheet in which the release sheet formed of the polyolefin-based film is adhered to both surfaces of a pressure-sensitive adhesive layer is used, there has been a following problem. Because the release sheet formed of the polyolefin-based film does not have thermal resistance, when the top of the release sheet is coated with a pressure-sensitive adhesive and then dried to thereby form the pressure-sensitive adhesive sheet, a sagging or a winkle is generated on the release sheet under high temperature conditions (for example, 110° C. or higher) due to thermal shrinkage, and the release force of the obtained pressure-sensitive adhesive sheet does not stabilize, whereby a so-called adhesive residue of the pressure-sensitive adhesive layer occurs, which means that a part of the pressure-sensitive adhesive layer ruptures and is attached to the released release sheet side.

Further, the inside of an electronic part such as a hard disk may become high temperature atmosphere during operation, and when a gas is generated from the pressure-sensitive adhesive layer adhered to the electronic part under the high temperature atmosphere, there may be caused an unpreferable situation such as corrosion or malfunction of the electronic part. In order to suppress the generation of the gas, it is necessary to increase the drying temperature at the time of forming the pressure-sensitive adhesive layer thereby volatilizing the substances having low boiling points such as a solvent and an unreacted monomer. In the release sheet described in JP 3886225 B, the problem of the above-mentioned thermal resistance occurs.

By the way, it is practically necessary to set a difference between release forces of the two release sheets for a double-sided pressure-sensitive adhesive sheet, and there are several proposals therefor (for example, JP 2005-47175 A, JP 2005-317613 A, and JP 2007-217553 A).

However, because a silicone compound is used in any cases, the above fundamental problems are remained and the double-sided pressure-sensitive adhesive sheet cannot be used in a double-sided pressure-sensitive adhesive sheet for electronic parts.

### SUMMARY OF THE INVENTION

It is an object of the present invention to provide a double-sided pressure-sensitive adhesive sheet which is free from adverse affects on electronic parts or the like and is excellent in releasing performance and a production method thereof.

In order to achieve the above object, the inventors of the present invention have conducted intensive studies, and hence found that the above object can be attained by using a specific heavy release agent which is free of a silicone compound for a release agent layer. The present invention has been accomplished based on this finding.

The present invention provides:

(1) A double-sided pressure-sensitive adhesive sheet including: a pressure-sensitive adhesive layer; a first release sheet having a first release agent layer adhered to one surface of the pressure-sensitive adhesive layer; and a second release sheet having a second release agent layer adhered to another surface of the pressure-sensitive adhesive layer, in which the first release agent layer and the second release agent layer are each formed by using a diene-based polymeric compound; when, at ordinary temperatures, a release force of the first release sheet to the pressure-sensitive adhesive layer is represented by X and a release force of the second release sheet to the pressure-sensitive adhesive layer is represented by Y, a relationship of Y−X≧50 is satisfied and Y represents 2,000 or less, where units of X and Y are each mN/20 mm; and the pressure-sensitive adhesive layer, the first release agent layer, and the second release agent layer are each substantially free of silicone compounds;
(2) A double-sided pressure-sensitive adhesive sheet according to the item (1), in which, when, after the double-sided pressure-sensitive adhesive sheet is left to stand for 168 hours under a 70° C. environment, a release force of the first release sheet to the pressure-sensitive adhesive layer is represented by X′ and a release force of the second release sheet to the pressure-sensitive adhesive layer is represented by Y′, a relationship of Y′−X′≧50 is satisfied and Y′ represents 2,000 or less, where units of X′ and Y′ are each mN/20 mm;
(3) A double-sided pressure-sensitive adhesive sheet according to the item (1), in which the first release agent layer and the second release agent layer each formed by using the diene-based polymer compound are formed by curing with active energy;
(4) A double-sided pressure-sensitive adhesive sheet according to the item (1), in which: the diene-based polymeric compound includes 1,4-polybutadiene; and the second release agent layer contains a heavy release agent;
(5) A double-sided pressure-sensitive adhesive sheet according to the item (4), in which the heavy release agent includes 1,2-polybutadiene;
(6) A double-sided pressure-sensitive adhesive sheet according to item (1), in which the pressure-sensitive adhesive layer generates a gas in an amount of 1.0 μg/cm² or less in terms of n-decane when heated at 120° C. for 10 minutes;
(7) A double-sided pressure-sensitive adhesive sheet according to the item (1), in which a resin component of the pressure-sensitive adhesive layer contains morpholine;
(8) A double-sided pressure-sensitive adhesive sheet according to the item (1), in which the first release agent layer and the second release agent layer each contain an antioxidant;
(9) A double-sided pressure-sensitive adhesive sheet according to the item (1), which is used for an electronic part; and
(10) A production method for the double-sided pressure-sensitive adhesive sheet according to the item (1) including: forming a coating film by coating a top of a second release sheet with a material for forming a pressure-sensitive adhesive layer, the material containing a pressure-sensitive adhesive; forming the pressure-sensitive adhesive layer by drying the coating film; and adhering a first release sheet to a surface of an opposite side of the formed pressure-sensitive adhesive layer to which the second release sheet is adhered.

According to the present invention, there can be provided a double-sided pressure-sensitive adhesive sheet which is free from adverse affects on electronic parts such as relays, various kinds of switches, connectors, motors, and hard disks and is excellent in releasing performance and a production method thereof.

### BRIEF DESCRIPTION OF THE DRAWINGS

In the accompanying drawings:

FIG. 1 is a cross-sectional view illustrating a double-sided pressure-sensitive adhesive sheet of the present invention; and

FIGS. 2(a) to 2(d) are process drawings illustrating an example of a production method for the double-sided pressure-sensitive adhesive sheet of the present invention.

### DETAILED DESCRIPTION OF THE PREFERRED EMBODIMENTS

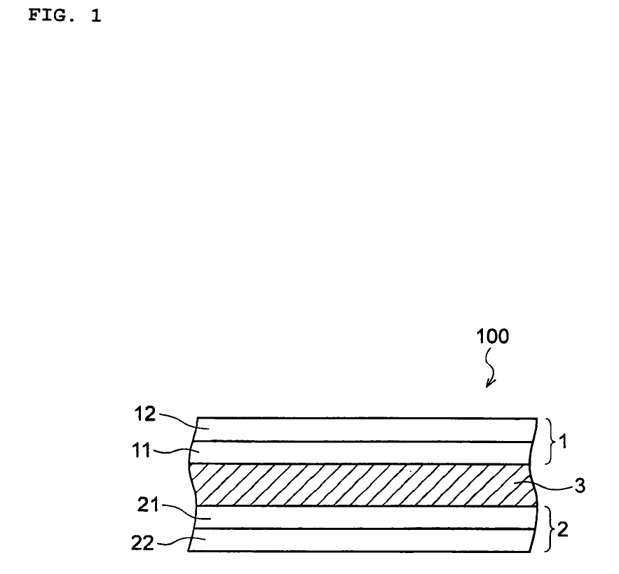

Hereinafter, the present invention is described in detail based on FIG. 1 illustrating an embodiment.

FIG. 1 is a cross-sectional schematic view illustrating a laminate structure of a double-sided pressure-sensitive adhesive sheet according to the present invention. It is to be noted that, in the following description, the upper side of FIG. 1 is referred to as “top” or “upper”, and the lower side of FIG. 1 is referred to as “bottom” or “lower”. As shown in FIG. 1, a double-sided pressure-sensitive adhesive sheet 100 includes: a pressure-sensitive adhesive layer 3; a first release sheet 1 adhered to one surface of the pressure-sensitive adhesive layer 3 and composed of a first release sheet substrate 12 and a first release agent layer 11; and a second release sheet 2 adhered to the other surface of the pressure-sensitive adhesive layer 3 and composed of a second release sheet substrate 22 and a second release agent layer 21.

The double-sided pressure-sensitive adhesive sheet of the present invention is adhered to electronic parts such as relays, semi-conductor wafers, various kinds of switches, connectors, motors, and hard disks, and a first release agent layer of a first release sheet and a second release agent layer of a second release sheet are each formed of a diene-based polymeric compound.

In the double-sided pressure-sensitive adhesive sheet of the present invention, when, at ordinary temperatures, a release force of the first release sheet to the pressure-sensitive adhesive layer is represented by X and a release force of the second release sheet to the pressure-sensitive adhesive layer is represented by Y, a relationship of Y−X≧50 is satisfied and Y represents 2,000 or less, where units of X and Y are each mN/20 mm.

Further, the pressure-sensitive adhesive layer, the first release agent layer, and the second release agent layer are each substantially free of a silicone compound. By taking such a constitution, the double-sided pressure-sensitive adhesive sheet of the present invention becomes the sheet which is free from adverse affects on electronic parts as described above. Further, the double-sided pressure-sensitive adhesive sheet of the present invention can prevent the following phenomena: when the first release sheet is released, the releasing is occurred at the interface of the second release sheet and the pressure-sensitive adhesive layer; and in releasing the first release sheet, a part of the pressure-sensitive adhesive layer, which supposed to be remained on the top of the second release sheet, trails the first release sheet and is released from the top of the second release sheet and attached to the first release sheet. In the double-sided pressure-sensitive adhesive sheet 100, the first release sheet 1 is released from the pressure-sensitive adhesive layer 3, and then the surface of the pressure-sensitive adhesive layer 3 from which the first release sheet 1 is released is adhered to an adherend. After that, the second release sheet 2 is released from the pressure-sensitive adhesive layer 3, and thus, the adherend can be adhered to another adherend or the like.

At first, the first release sheet 1 is described in detail. As illustrated in FIG. 1, the first release sheet 1 is formed of the first release sheet substrate 12 and the first release agent layer 11. The release force of the first release sheet 1 to the pressure-sensitive adhesive layer 3 is smaller by a predetermined degree than the release force of the second release sheet 2, which is described below, to the pressure-sensitive adhesive layer 3. Specifically, the release force of the first release sheet 1 to the pressure-sensitive adhesive layer 3 is preferably 50 to 300 mN/20 mm and more preferably 70 to 250 mN/20 mm. Thus, the first release sheet 1 can be released satisfactorily from the pressure-sensitive adhesive layer 3.

The first release sheet substrate 12 has a function of supporting the first release agent layer 11, and is formed of, for example: a polyester film such as a polyethylene terephthalate film or a polybutylene terephthalate film; a polyolefin film such as a polypropylene film or a polymethylpentene film; a plastic film such as a polycarbonate film; a metal foil of aluminum or stainless steel; and paper such as glassine paper, high-quality paper, coated paper, impregnated paper, or synthetic paper. When the plastic film is used as the release sheet substrate, for the purposes of improving the adhesiveness of the plastic film to the release agent layer and the like, the surface of the plastic film on which the release agent layer is provided can be subjected to a physical or chemical surface treatment such as an oxidation method or an irregularity method, as desired. Examples of the oxidation method include corona discharge treatment, chromic acid treatment, flame treatment, hot air treatment, and ozone/ultra violet irradiation treatment. Further, examples of the irregularity method include a sandblasting method and a solvent treatment method. Those surface treatment methods are appropriately selected according to the kind of the substrate, and in general, the corona discharge treatment method is preferably used in terms of the effect and operability thereof. Further, the substrate can also be subjected to primer treatment.

The average thickness of the first release sheet substrate 12 is not particularly limited, and is preferably 10 to 200 μm and more preferably 15 to 100 μm. The first release agent layer 11 is formed of a material which is substantially free of a silicone compound. Thus, in the double-sided pressure-sensitive adhesive sheet 100, the silicone compound is prevented from being transferred from the first release agent layer 11 to the pressure-sensitive adhesive layer 3. As a result, after the pressure-sensitive adhesive layer 3 is adhered to an adherend, the silicone compound is prevented from being discharged from the pressure-sensitive adhesive layer 3. Therefore, when the adherend is an electronic part such as a relay, the pressure-sensitive adhesive layer 3 is free from an adverse affect on the adherend.

It is to be noted that, in the specification of the present invention, the phrase “substantially free of a silicone compound” means that the amount of the silicone compound measured by an X-ray photoelectron spectroscopy is preferably 0.5% by atom or less and more preferably 0.1% by atom or less. The measurement conditions of the X-ray photoelectron spectroscopy and the calculation of the measured value are performed by the following method.

X-ray: AlKα (1486.6 eV)

Take-off angle: 45°

Measurement element: silicon (Si) and carbon (C), the amount of silicone compound is calculated by multiplying the valency of Si/(Si+C) by 100, and is expressed by “% by atom”.

As a release agent used to form the first release agent layer 11, a diene-based polymeric compound is suitably used. Examples of the diene-based polymeric compound include: diene-based homopolymers such as polybutadiene and polyisoprene; and diene-based copolymers such as a styrene-butadiene copolymer and a styrene-isoprene copolymer. In particular, polybutadiene and polyisoprene are suitably used.

Of the diene-based polymeric compounds, preferred is polybutadiene, and more specifically, preferred is 1,4-polybutadiene. 1,4-polybutadiene may have any of a cis configuration and a trans configuration, and 1,4-polybutadiene with arbitrary cis configuration content can be used.

The first release agent layer of the first release sheet can be formed by: producing a first release agent solution in which the diene-based polymeric compound is dissolved in an organic solvent; coating the release sheet substrate with the first release agent solution; heating the resultant at temperature of about 40 to 160° C. for about 30 seconds to 1 minute to thereby evaporate the organic solvent; and, if required, irradiating the resultant with an active energy ray such as a UV ray to thereby cross-link the diene-based polymeric compound.

Typical examples of the active energy ray include a UV ray and an electron ray. For example, in the case of a ultra violet irradiation, usable as UV lamps are a high-pressure mercury lamp, a metal halide lamp, a high-power metal halide lamp, and an electrodeless lamp, which are conventionally known, and the electrodeless lamp is suitable in terms of cross-linking property of the diene-based polymeric compound. In the case of the ultraviolet irradiation, the amount of irradiation is, from the viewpoint of attaining high adhesiveness between the first release sheet substrate and the first release agent layer, preferably 10 mJ/cm² or more and 1,000 mJ/cm² or less. The amount of the ultra violet irradiation is more preferably in a range of 70 to 500 mJ/cm² and particularly preferably in a range of 100 to 300 mJ/cm². In the case of cross-linking the diene-based polymeric compound by the ultra violet irradiation, the cross-linking can be performed further effectively when a photosensitizer is added to the release agent solution.

Specific examples of the photosensitizer include aromatic ketones such as benzophenone, p,p′-dimethoxybenzophenone, p,p′-dichlorobenzophenone, p,p′-dimethylbenzophenone, acetophenone, and acetonaphthone, which provide good results. In addition, there can be used an aromatic aldehyde such as terephthalaldehyde and a quinone-based aromatic compound such as methylanthraquinone. The addition amount of the photosensitizer is generally 0.1 to 10 parts by mass and preferably 1 to 5 parts by mass with respect to 100 parts by mass of the diene-based polymeric compound.

As the organic solvent, which is used for producing the first release agent solution for forming the first release agent layer, a solvent can be appropriately selected from the known solvents each having good solubility with the diene-based polymeric compound and used. Examples of the organic solvent include toluene, xylene, methanol, ethanol, isobutanol, n-butanol, acetone, methyl ethyl ketone, and tetra hydrofuran. One kind of the solvent may be used alone, or two or more kinds of those solvents may be used in combination. For convenience of coating, the first release agent solution is prepared by using those organic solvents so as to have a solid content preferably in a range of 0.1 to 10% by mass and more preferably in a range of 0.3 to 5% by mass.

The coating amount of the first release agent solution, in thickness, is preferably 0.01 μm or more in order to obtain a necessary release force (light releasing), and is preferably 1 μm or less and particularly preferably in a range of 0.02 to 0.8 μm in order to prevent the occurrence of blocking. The top of the coating of the release sheet substrate with the first release agent solution is performed by a conventionally known method such as a bar coating method, a reverse roll coating method, a knife coating method, a roll knife coating method, a gravure coating method, an air doctor coating method, or a doctor blade coating method.

In the present invention, the first release agent layer may contain an antioxidant.

There is no particular limitation on the antioxidant, and any of various known phosphite-based antioxidants, organic sulfur-based antioxidants, hindered phenol-based antioxidants may be used.

One kind of the antioxidant may be used alone, or two or more kinds of those antioxidants may be used in combination. Further, the use amount thereof is preferably 0.01 part by mass or more with respect to 100 parts by mass of the diene-based polymeric compound from the viewpoint of preventing the releasing from becoming heavy due to the deterioration of the diene-based polymeric compound, and is preferably 10 parts by mass or less with respect to 100 parts by mass of the diene-based polymeric compound from the viewpoint of sufficiently maintaining the adhesiveness between the first release agent layer and the release sheet substrate. It is more preferred that the use amount be in a range of 0.05 to 5 parts by mass with respect to 100 parts by mass of the diene-based polymeric compound.

The release agent solution is obtained by dissolving, in the organic solvent, the diene-based polymeric compound and, if required, other components to be blended (an antistat, a photoinitiator, a plasticizer, a stabilizer, and the like).

In the double-sided pressure-sensitive adhesive sheet of the present invention, an undercoat layer can be interposed between the release sheet substrate and the release agent layer, if required. By the inter position of the undercoat layer, there is an advantage in that adhesiveness and stable release force can be achieved. As a material for forming the undercoat layer, an elastic body can be exemplified (herein after the undercoat layer may be referred to as “elastic body layer”). As the elastic body, usable are natural resins such as a natural rubber and synthetic resins such as a polyurethane-based resin, an ethylene-vinyl acetate copolymer, and a polyolefin-based resin, or an elastic body formed of synthetic rubber materials such as a styrene butadiene-based rubber, a butyl-based rubber, an ethylene-propylene-based rubber, and an acrylic rubber. The synthetic resin, in particular, a polyurethane resin such as a polyurethane elastomer or a modified polyurethane elastomer is preferred, because the polyurethane resin has solvent resistance (is insoluble) to the organic solvent used for the release agent solution and has excellent rubber elasticity.

The elastic body layer can be formed by coating the top of the release sheet substrate with an undercoat liquid in which the above-mentioned materials are dissolved in the organic solvent, and drying the resultant. In addition, ultra violet irradiation is performed after the coating and the drying if required, whereby the solvent resistance of the elastic body layer and the adhesion of the elastic body layer with the substrate can be improved. In the case where the undercoat layer is interposed, an antioxidant, a photosensitizer, and the like can be blended therein, if required.

As an organic solvent used for preparing the undercoat liquid, a solvent can be appropriately selected from the known solvents each having good solubility with the material for forming the undercoat layer and used. Examples of the solvent include toluene, xylene, methanol, ethanol, isobutanol, n-butanol, acetone, methyl ethyl ketone, and tetra hydrofuran. One kind of the solvent may be used alone, or two or more kinds of those solvents may be used in combination.

For convenience of coating, the undercoat liquid is prepared by using those organic solvents so as to have a solid content preferably in a range of about 0.1 to 15% by mass and more preferably in a range of 0.5 to 5% by mass. The coating of the top of the release sheet substrate with the undercoat liquid is performed by a conventionally known method such as a bar coating method, a reverse roll coating method, a knife coating method, a roll knife coating method, a gravure coating method, an air doctor coating method, or a doctor blade coating method.

The undercoat layer is formed by: coating the top of the release sheet substrate with the undercoat liquid; and heating the resultant at temperature of about 40 to 160° C. for about 30 seconds to 2 minutes thereby drying the resultant. The coating amount of the undercoat liquid, in thickness, is preferably 0.01 μm or more in order to obtain releasing stability over time, which is an effect obtained by providing the undercoat layer. The thickness which does not cause blocking and is economical and effective is preferably 5 μm or less and particularly preferably in a range of 0.1 to 1 μm.

Thus, the first release sheet 1 can be more satisfactorily released from the pressure-sensitive adhesive layer 3, and the difference between the release force of the first release sheet 1 to the pressure-sensitive adhesive layer 3 and the release force of the second release sheet 2, which is described below, to the pressure-sensitive adhesive layer 3 can be made more suitable.

Subsequently, the second release sheet 2 is described in detail.

As illustrated in FIG. 1, the second release sheet 2 is formed of the second release sheet substrate 22 and the second release agent layer 21. The release force of the second release sheet 2 to the pressure-sensitive adhesive layer 3 is larger by a predetermined degree than the release force of the first release sheet 1 to the pressure-sensitive adhesive layer 3. Specifically, the release force of the second release sheet 2 to the pressure-sensitive adhesive layer 3 is preferably 150 to 700 mN/20 mm and more preferably 200 to 500 mN/20 mm, and a release force Y of the second release sheet should not exceed 2,000 mN/20 mm. Thus, the second release sheet 2 can be released satisfactorily from the pressure-sensitive adhesive layer 3, and at the same time, the following phenomena can be effectively prevented from occurring: in releasing the first release sheet 1 from the pressure-sensitive adhesive layer 3, the second release sheet 2 is inappropriately released from the pressure-sensitive adhesive layer 3; and in releasing the first release sheet, a part of the pressure-sensitive adhesive layer, which supposed to be remained on the top of the second release sheet, trails the first release sheet and is released from the top of the second release sheet and attached to the first release sheet.

The second release sheet substrate 22 has a function of supporting the second release agent layer 21. As the materials for forming the second release sheet substrate 22, the same materials as those described for the first release sheet substrate 12 can be used. The average thickness of the second release sheet substrate 22 is not particularly limited, and is preferably 10 to 200 μm and more preferably 15 to 100 μm.

The second release agent layer 21 is, as in the first release agent layer 11, formed of a material which is substantially free of a silicone compound. Thus, in the double-sided pressure-sensitive adhesive sheet 100, the silicone compound is prevented from being transferred from the second release agent layer 21 to the pressure-sensitive adhesive layer 3. As a result, after the pressure-sensitive adhesive layer 3 is adhered to an adherend, the silicone compound is prevented from being discharged from the pressure-sensitive adhesive layer 3. Therefore, even when the adherend is an electronic part such as a relay, the pressure-sensitive adhesive layer 3 is free from an adverse affect on the adherend.

As a release agent used to form the second release agent layer 21, a diene-based polymeric compound is suitably used as in the case of the first release agent layer 11. Examples of the diene-based polymeric compound include: diene-based homopolymers such as polybutadiene and polyisoprene; and diene-based copolymers such as a styrene-butadiene copolymer and a styrene-isoprene copolymer. In particular, polybutadiene and polyisoprene are suitably used.

Of the diene-based polymeric compounds, preferred is polybutadiene, and more specifically, preferred is 1,4-polybutadiene. 1,4-polybutadiene may have any of a cis configuration and a trans configuration, and 1,4-polybutadiene with arbitrary cis configuration content can be used. It is to be noted that, in order to allow the release force of the second release agent layer to be larger by a predetermined degree than that of the first release agent layer, a heavy release agent is added to adjust the release force. In the case of the present invention, it is preferred to add, as the heavy release agent, 1,4-polybutadiene as a main component, and 1,2-polybutadiene and polyisoprene. The addition amount of the heavy release agent can be set in accordance with a target release force.

In addition, a styrene-butadiene-styrene copolymer, a styrene-isoprene-styrene copolymer, an EPDM, a butyl rubber, a nitrile rubber, and the like can also be used as the heavy release agent.

By taking the above-mentioned constitution, the second release sheet 2 can be released satisfactorily from the pressure-sensitive adhesive layer 3, and at the same time, the following phenomena can be effectively prevented from occurring: in releasing the first release sheet 1 from the pressure-sensitive adhesive layer 3, the second release sheet 2 is inappropriately released from the pressure-sensitive adhesive layer 3; and in releasing the first release sheet, a part of the pressure-sensitive adhesive layer, which supposed to be remained on the top of the second release sheet, trails the first release sheet and is released from the top of the second release sheet and attached to the first release sheet.

The average thickness of the second release agent layer 21 is not particularly limited, and is preferably about 0.02 to 1.00 μm and more preferably 0.05 to 0.80 μm. It is to be noted that the second release agent layer 21 may contain another resin component and various additives such as an antioxidant, a plasticizer, and a stabilizer in a range less than 5% by mass, as long as the releasability thereof is not impaired and a silicone compound is not contained.

Further, in the second release sheet 2, an undercoat layer may be interposed between the second release agent layer 21 and the second release sheet substrate 22 as in the first release sheet 1. By taking such a constitution, the adhesiveness between the second release agent layer 21 and the second release sheet substrate 22 is improved, and the following can be satisfactorily prevented from occurring: in releasing the second release sheet 2 from the pressure-sensitive adhesive layer 3, the releasing is occurred at the interface of the second release agent layer 21 and the second release sheet substrate 22; and after the releasing, a part of the second release agent layer 21 is attached to the top of the pressure-sensitive adhesive layer 3 and remains thereon. It is to be noted that the production method and the like of the second release sheet is the same as those in the case of the first release sheet.

In the present invention having the above-mentioned constitution, when, at an ordinary temperature (23° C., 50% RH), a release force of the first release sheet 1 to the pressure-sensitive adhesive layer 3 is represented by X and a release force of the second release sheet 2 to the pressure-sensitive adhesive layer 3 is represented by Y, the first release sheet 1 and the second release sheet 2 satisfy a relationship of Y−X≧50 and Y represents 2,000 or less. The units of X and Y are each mN/20 mm. Thus, the following phenomena can be surely prevented from occurring: in releasing the first release sheet 1 from the pressure-sensitive adhesive layer 3, the second release sheet 2 is inappropriately released from the pressure-sensitive adhesive layer 3; and in releasing the first release sheet, a part of the pressure-sensitive adhesive layer, which supposed to be remained on the top of the second release sheet, trails the first release sheet and is released from the top of the second release sheet and attached to the first release sheet.

It is to be noted that, when the release force of the first release sheet 1 to the pressure-sensitive adhesive layer 3 is represented by X [mN/20 mm] and the release force of the second release sheet 2 to the pressure-sensitive adhesive layer 3 is represented by Y [mN/20 mm], the first release sheet 1 and the second release sheet 2 satisfy the relationship of Y−X≧50, and more preferably satisfy a relationship of 2,000>Y−X≧100. Thus, the effect of the present invention can be made more prominent.

Further, when a release force of the first release sheet 1 to the pressure-sensitive adhesive layer 3 after being left to stand for 168 hours under a 70° C. environment is represented by X′ [mN/20 mm] and a release force of the second release sheet 2 to the pressure-sensitive adhesive layer 3 after being left to stand for 168 hours under a 70° C. environment is represented by Y′ [mN/20 mm], the first release sheet 1 and the second release sheet 2 having the above-mentioned constitution satisfy a relationship of Y′−X′≧50. In addition, Y′ also preferably represents 2,000 mN/20 mm or less, as in the case of Y. Thus, the following phenomena can be surely prevented from occurring: in releasing the first release sheet 1 from the pressure-sensitive adhesive layer 3, the second release sheet 2 is inappropriately released from the pressure-sensitive adhesive layer 3; and in releasing the first release sheet 1, a part of the pressure-sensitive adhesive layer, which supposed to be remained on the top of the second release sheet, trails the first release sheet and is released from the top of the second release sheet and attached to the first release sheet.

It is to be noted that, when the release force of the first release sheet 1 to the pressure-sensitive adhesive layer 3 after being left to stand for 168 hours under a 70° C. environment is represented by X′ [mN/20 mm] and the release force of the second release sheet 2 to the pressure-sensitive adhesive layer 3 after being left to stand for 168 hours under a 70° C. environment is represented by Y′ [mN/20 mm], the first release sheet 1 and the second release sheet 2 satisfy the relationship of Y′-X′≧50, and more preferably satisfy a relationship of 2,000≧Y′-X′≧100. Thus, the effect of the present invention can be made more prominent.

It is to be noted that the release forces are measured by measurement methods to be described herein after.

Subsequently, the pressure-sensitive adhesive layer 3 is described in detail. In the double-sided pressure-sensitive adhesive sheet 100, as illustrated in FIG. 1, the pressure-sensitive adhesive layer 3 has the first release sheet 1 adhered to one surface thereof and the second release sheet 2 adhered to the other surface thereof, and is capable of adhering to an adherend by releasing the respective release sheets. The pressure-sensitive adhesive layer 3 is formed of a pressure-sensitive adhesive composition having a pressure-sensitive adhesive as a base compound. Examples of the pressure-sensitive adhesive include an acrylic pressure-sensitive adhesive, a polyester-based pressure-sensitive adhesive, and a urethane-based pressure-sensitive adhesive. For example, in the case where the pressure-sensitive adhesive is an acrylic pressure-sensitive adhesive, the composition can be formed of a main monomer component for imparting pressure-sensitive adhesive property, a comonomer component for imparting adhesive property and cohesive force, and a polymer or a copolymer having as a main component a functional group-containing monomer component for improving cross-linking point and adhesive property. Examples of the main monomer component include alkyl acrylates such as ethyl acrylate, butyl acrylate, amyl acrylate, 2-ethylhexyl acrylate, octyl acrylate, cyclohexyl acrylate, benzyl acrylate, and methoxyethyl acrylate, and alkyl methacrylates such as butyl methacrylate, 2-ethylhexylmethacrylate, cyclohexylmethacrylate, and benzyl methacrylate. Examples of the comonomer component include methyl acrylate, methyl methacrylate, ethyl methacrylate, vinyl acetate, styrene, and acrylonitrile. Examples of the functional group-containing monomer component include carboxyl group-containing monomers such as acrylic acid, methacrylic acid, maleic acid, and itaconic acid, hydroxyl group-containing monomers such as 2-hydroxyethyl acrylate, 2-hydroxyethyl methacrylate, 2-hydroxypropyl acrylate, 2-hydroxypropyl methacrylate, and N-methylol acrylamide, acrylamide, methacrylamide, glycidyl methacrylate, N-vinylmorpholine, N-allylmorpholine, and N-(meth)acryloylmorpholine. When those components are contained, adhesive force and cohesive force of the pressure-sensitive adhesive layer are improved.

As one of the functional group-containing monomer components, preferably used is N-vinylmorpholine, N-allylmorpholine, N-(meth)acryloylmorpholine, or the like, which is a ethylenic unsaturated monomer having a six-membered heterocyclic ring having a nitrogen atom and an oxygen atom, because the component exhibits a function as a cross-linking promoter at the time of the reaction with a cross-linking agent described below. Of those, N-(meth)acryloylmorpholine is particularly preferably used from the viewpoint of its satisfactory copolymerizability with another monomer component.

Further, the acrylic resin generally does not have an unsaturated bond, and hence can improve the stability against light and oxygen. In addition, the kind and the molecular weight of the monomer are appropriately selected, to thereby obtain a pressure-sensitive adhesive composition having application-specific quality and properties. Any of a cross-linked pressure-sensitive adhesive composition which is subjected to cross-linking treatment and a non-cross-linked pressure-sensitive adhesive composition which is not subjected to cross-linking treatment may be used, and the cross-linked pressure-sensitive adhesive composition is more preferred. In the case where the cross-linked pressure-sensitive adhesive composition is used, the pressure-sensitive adhesive layer 3 which has further enhanced cohesive force can be formed. Examples of the cross-linking agent to be used for the cross-linked pressure-sensitive adhesive composition include an epoxy-based compound, an isocyanate-based compound, a metal chelate compound, a metal alkoxide, a metal salt, an amine compound, a hydrazine compound, an aldehyde compound.

It is to be noted that, in the present invention, a pressure-sensitive adhesive layer which has pressure-sensitive adhesive layers on both surfaces of the substrate is regarded as the same as the above pressure-sensitive adhesive layer. The same substrates as those used for the first and the second release sheets can be used.

Further, the pressure-sensitive adhesive composition to be used in the present invention may contain various kinds of additives such as an antioxidant, a plasticizer, a tackifier, and a stabilizer, if required. The average thickness of the pressure-sensitive adhesive layer 3 is not particularly limited, and is preferably 5 to 200 μm and more preferably 10 to 100 μm. The pressure-sensitive adhesive layer 3 as described above generates a gas in an amount of preferably 1.0 μg/cm² or less and more preferably 0.5 μg/cm² or less in terms of n-decane when heated at 120° C. for 10 minutes. Thus, malfunction of an electronic part caused by the gas generated when the inside of the electronic part such as a hard disk becomes high temperature due to operation thereof can be effectively prevented from occurring.

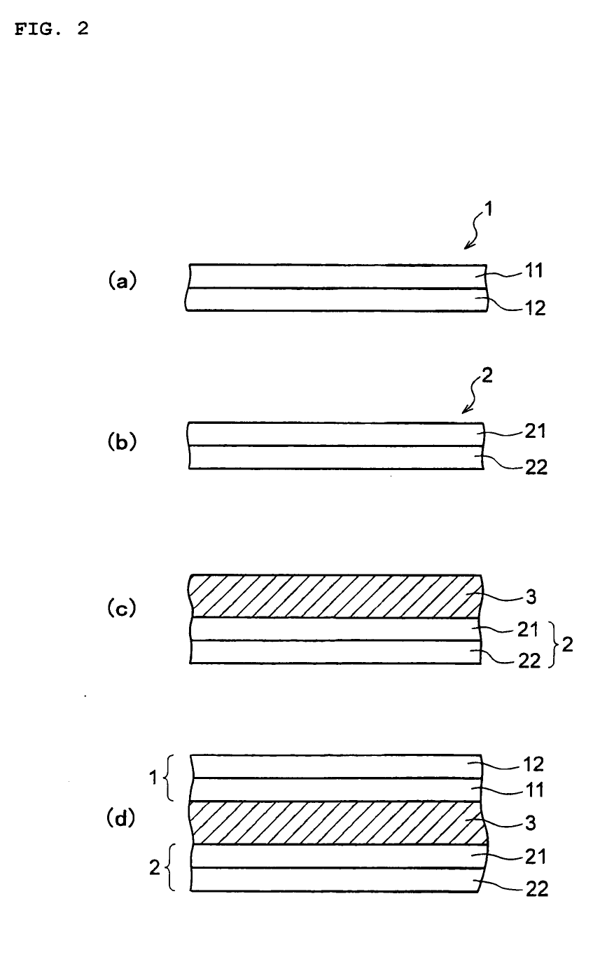

Subsequently, a production method for the double-sided pressure-sensitive adhesive sheet of the present invention is described using FIGS. 2(a) to 2(d). FIGS. 2(a) to 2(d) are process drawings illustrating an example of a production method for the double-sided pressure-sensitive adhesive sheet of the present invention. First, a first release sheet substrate 12 is prepared. Subsequently, an undercoat layer is provided on the top of the first release sheet substrate 12 as desired and coated with a material for forming a first release agent layer containing a diene-based polymeric compound, and thereafter subjecting the resultant to drying treatment, ultra violet irradiation treatment, and the like, if required, whereby a first release agent layer 11 is formed as illustrated in FIG. 2 (a). Thus, a first release sheet 1 is obtained.

On the other hand, a second release sheet substrate 22 is prepared. Subsequently, the top of the second release sheet substrate 22 is coated with a material for forming a second release agent layer containing a diene-based polymeric compound as desired, and thereafter subjecting the resultant to drying treatment, ultra violet irradiation treatment, and the like, if required, whereby a second release agent layer 21 is formed as illustrated in FIG. 2 (b). Thus, a second release sheet 2 is obtained. As a method of coating the top of the first release sheet substrate and the top of the second release sheet substrate with the material for forming a first release agent layer and the material for forming a second release agent layer, respectively, there are used existing methods such as a gravure coating method, a bar coating method, a spray coating method, a knife coating method, a roll coating method, and a die coating method.

Subsequently, the top of the second release agent layer 21 of the second release sheet 2 is coated with a material for forming a pressure-sensitive adhesive layer containing a pressure-sensitive adhesive, whereby a coating film is formed. Subsequently the coating film is dried, whereby a pressure-sensitive adhesive layer 3 is formed on the top of the second release sheet 2 as illustrated in FIG. 2(c). Thus, by firstly forming the pressure-sensitive adhesive layer 3 on the top of the second release sheet 2, the pressure-sensitive adhesive layer 3 can be satisfactorily formed. In contrast, when it is attempted to form the pressure-sensitive adhesive layer 3 directly on the top of the first release sheet 1, the adhesiveness of the pressure-sensitive adhesive layer 3 with the first release agent layer 11 may become high at the time of drying the coating film, and the release force between the first release sheet 1 and the pressure-sensitive adhesive layer 3 may become large. Thus, it may become difficult to obtain a sufficient difference between the release force of the first release sheet 1 to the pressure-sensitive adhesive layer 3 and the release force of the second release sheet 2 to the pressure-sensitive adhesive layer 3. As a method of coating the top of the second release sheet 2 with the material for forming a pressure-sensitive adhesive layer, there are used existing methods such as a gravure coating method, a bar coating method, a knife coating method, a roll coating method, and a die coating method. Examples of the form of the material for forming a pressure-sensitive adhesive layer in this case include a solvent type and an emulsion type. As for drying conditions of the pressure-sensitive adhesive, the heating temperature is preferably 80 to 140° C. and more preferably 90 to 120°, and the heating time is not particularly limited and is preferably 30 seconds to 5 minutes. Subsequently, as illustrated in FIG. 2(d), the first release sheet 1 is adhered to the pressure-sensitive adhesive layer 3 which is formed on the top of the second release sheet 2, whereby a double-sided pressure-sensitive adhesive sheet 100 is obtained.

The preferred embodiment of the double-sided pressure-sensitive adhesive sheet and the production method thereof according to the present invention has been described above, but the present invention is not limited thereto. Further, the application of the double-sided pressure-sensitive adhesive sheet of the present invention is not limited to the above-mentioned electronic parts such as relays, various kinds of switches, connectors, motors, and hard disks.

### EXAMPLES

Hereinafter, the double-sided pressure-sensitive adhesive sheet of the present invention is specifically described by way of examples and comparative examples, but the present invention is not limited by those examples and comparative examples.

### Example 1

### Production of First Release Sheet

The top of a polyethylene terephthalate film (T100 manufactured by Mitsubishi Polyester Film GmbH) having a thickness of 38 μm as a release sheet substrate was coated with a solution, as an undercoat layer, which was prepared by diluting 100 parts by mass of a polyurethane solution (CRISVON 5150S manufactured by DIC Corporation, solution having solid content of 50% by mass, solvent: methyl ethyl ketone) and 5 parts by mass of an isocyanate cross-linking agent (CRISVON NX manufactured by DIC Corporation) in a methyl ethyl ketone solution so as to have a solid content of 1% by mass. The coating was performed in such a manner that the layer thickness after drying was 0.15 μm, and the drying was performed at 100° C. for 1 minute to thereby form the undercoat layer. Then, the top of the undercoat layer was coated with a solution, as a release agent layer, which was prepared by diluting 100 parts by mass of 1,4-polybutadiene (BR-01 manufactured by JSR Corporation, solution having solid content of 5% by mass, solvent: toluene) and 1 part by mass of an antioxidant (IRGANOX HP 2251 manufactured by Ciba Specialty Chemicals) in a toluene solvent so as to have a solid content of 0.5% by mass. The coating was performed in such a manner that the layer thickness after drying was 0.1 μm, and the drying was performed at 100° C. for 30 seconds. Subsequently, the coating layer was subjected to ultra violet irradiation by using a belt conveyer-type ultra violet irradiation apparatus equipped with one Fusion H bulb of 240 W/cm under a condition of a conveyer rate at 40 m/min (ultra violet irradiation condition: 100 mJ/cm²), and was cured, whereby a first release sheet was obtained.

### <Production of Second Release Sheet>

The top of a polyethylene terephthalate film (T100 manufactured by Mitsubishi Polyester Film GmbH) having a thickness of 38 μm as a release sheet substrate was coated with a solution, as an undercoat layer, which was prepared by diluting 100 parts by mass of a polyurethane solution (CRISVON 5150S) and 5 parts by mass of an isocyanate cross-linking agent (CRISVON NX) in a methyl ethyl ketone solution so as to have a solid content of 1% by mass. The coating was performed in such a manner that the layer thickness after drying was 0.15 μm, and the drying was performed at 100° C. for 1 minute to thereby form the undercoat layer. Then, the top of the undercoat layer was coated with a solution, as a release agent layer, which was prepared by diluting 90 parts by mass of 1,4-polybutadiene (BR-01) and 10 parts by mass of 1,2-polybutadiene (BR-820 manufactured by JSR Corporation, solution having solid content of 5% by mass, solvent: toluene) in a toluene solvent so as to have a solid content of 0.5% by mass. The coating was performed in such a manner that the layer thickness after drying was 0.1 μm, and the drying was performed at 100° C. for 30 seconds. Subsequently, the coating layer was subjected to ultra violet irradiation by using a belt conveyer-type ultra violet irradiation apparatus equipped with one Fusion H bulb of 240 W/cm under a condition of a conveyer rate at 40 m/min (ultra violet irradiation condition: 100 mJ/cm²), and was cured, whereby a second release sheet was obtained.

### <Preparation of Pressure-Sensitive Adhesive>

83.0 parts by mass of butyl acrylate, 2.0 parts by mass of 2-hydroxyethyl acrylate, and 15.0 parts by mass of N-acryloylmorpholine were loaded into a reactor, and the mixture was heated to 80° C. to 90° C. while stirring to perform a polymerization reaction. The mixture was further polymerized for 7 hours while a polymerization catalyst solution in which 0.1 part by mass of azobisisobutyronitrile was dissolved in 10 parts by mass of toluene was sequentially added. After the completion of the reaction, a dilution (mixed solvent of toluene and ethyl acetate) was added to the resultant, whereby a 40% by mass solution of an acrylic copolymer was produced.

In 100 parts by mass of the acrylic copolymer solution (40 parts by mass in terms of solid content), 1 part by mass of a tolylene diisocyanate-based (TDI-based) cross-linking agent (Colonate L55E manufactured by Nippon Polyurethane Industry Co., Ltd.) was blended, whereby a pressure-sensitive adhesive composition solution (represented by “A” in Table 1 below) was prepared.

### <Production of Double-Sided Pressure-Sensitive Adhesive Sheet>

The top of the second release sheet produced as described above was coated with the pressure-sensitive adhesive composition solution in such a manner that the layer thickness after drying was about 25 μm by using a coating applicator, and the resultant was dried by heating at 120° C. for 1 minute, whereby a pressure-sensitive adhesive layer was formed. After that, the release agent layer of the first release sheet was adhered to the pressure-sensitive adhesive layer, whereby a double-sided pressure-sensitive adhesive sheet was obtained.

### Example 2

A double-sided pressure-sensitive adhesive sheet was produced in the same manner as in Example 1 except that a second release sheet was produced as follows.

The top of the undercoat layer was coated with a solution, as a second release agent layer of the second release sheet, which was prepared by diluting 85 parts by mass of 1,4-polybutadiene (BR-01) and 15 parts by mass of 1,2-polybutadiene (RB-820) in a toluene solvent so as to have a solid content of 0.5% by mass. The coating was performed in such a manner that the layer thickness after drying was 0.1 μm, and the drying was performed at 100° C. for 30 seconds. Subsequently, the coating layer was subjected to ultra violet irradiation by using the belt conveyer-type ultra violet irradiation apparatus equipped with one Fusion H bulb of 240 W/cm under a condition of a conveyer rate at 40 m/min (ultra violet irradiation condition: 100 mJ/cm²), and was cured, whereby the second release sheet was obtained.

### Example 3

A double-sided pressure-sensitive adhesive sheet was produced in the same manner as in Example 1 except that a solution for forming a pressure-sensitive adhesive layer was prepared as follows.

55.0 parts by mass of 2-ethylhexyl acrylate, 20.0 parts by mass of butyl acrylate, 23.0 parts by mass of vinyl acetate, and 2.0 parts by mass of acrylic acid were loaded into a reactor, and the mixture was heated to 80° C. to 90° C. while stirring to perform a polymerization reaction. The mixture was further polymerized for 7 hours while a polymerization catalyst solution in which 0.1 part by mass of azobisisobutyronitrile was dissolved in 10 parts by mass of toluene was sequentially added. After the completion of the reaction, a diluting solvent (mixed solvent of toluene and ethyl acetate) was added to the resultant, whereby a 30% by mass solution of an acrylic copolymer was produced. In 100 parts by mass of the acrylic copolymer solution (30 parts by mass in terms of a solid content), 0.1 part by mass of a metal chelate-based cross-linking agent (Alumichelate D manufactured by Kawaken Fine Chemicals Co., Ltd.) was blended, whereby a pressure-sensitive adhesive composition solution (represented by “B” in Table 1 below) was prepared.

### Example 4

A double-sided pressure-sensitive adhesive sheet was produced in the same manner as in Example 1 except that the release sheet was produced by using polyisoprene (LIR-30 manufactured by KURARAY CO., LTD, solution having a solid content of 5% by mass, solvent: toluene) instead of 1,4-polybutadiene (BR-01), which was the release agent layer used for the first release sheet.

### Example 5

A double-sided pressure-sensitive adhesive sheet was produced in the same manner as in Example 2 except that a first release sheet was produced as follows.

The top of the undercoat layer was coated with a solution, as a first release agent layer of the first release sheet, which was prepared by diluting 98 parts by mass of 1,4-polybutadiene (BR-01) and 2 parts by mass of 1,2-polybutadiene (RB-820) in a toluene solvent so as to have a solid content of 0.5% by mass. The coating was performed in such a manner that the layer thickness after drying was 0.1 μm, and the drying was performed at 100° C. for 30 seconds. Subsequently, the coating layer was subjected to ultra violet irradiation by using the belt conveyer-type ultra violet irradiation apparatus equipped with one Fusion H bulb of 240 W/cm under a condition of a conveyer rate at 40 m/min (ultra violet irradiation condition: 100 mJ/cm²), and was cured, whereby the first release sheet was obtained.

### Comparative Example 1

A double-sided pressure-sensitive adhesive sheet was produced in the same manner as in Example 1 except that, as the first release sheet, a release sheet (PET 381031 manufactured by Lintec Corporation) in which the release agent layer was formed using a silicone-based release agent on one surface of a PET film having an average thickness of 38 μm was used.

### Comparative Example 2

Two second release sheets were produced in the same manner as in Example 1. A double-sided pressure-sensitive adhesive sheet was produced in the same manner as in Example 1 except that the first release sheet was not used and those two second release sheets were used.

### Comparative Example 3

Two first release sheets were produced in the same manner as in Example 1. A double-sided pressure-sensitive adhesive sheet was produced in the same manner as in Example 1 except that the second release sheet was not used and those two first release sheets were used.

### Comparative Example 4

A double-sided pressure-sensitive adhesive sheet was produced in the same manner as in Example 1 except that a second release sheet was produced as follows.

The top of the undercoat layer was coated with a solution, as a second release agent layer of the second release sheet, which was prepared by diluting 50 parts by mass of 1,4-polybutadiene (BR-01) and 50 parts by mass of 1,2-polybutadiene (RB-820) in a toluene solvent so as to have a solid content of 0.5% by mass. The coating was performed in such a manner that the layer thickness after drying was 0.1 μm, and the drying was performed at 100° C. for 30 seconds. Subsequently, the coating layer was subjected to ultra violet irradiation by using the belt conveyer-type ultra violet irradiation apparatus equipped with one Fusion H bulb of 240 W/cm under a condition of a conveyer rate at 40 m/min (ultra violet irradiation condition: 100 mJ/cm²), and was cured, whereby the second release sheet was obtained.

The constituent materials and the compounding ratio thereof of the first release agent layer and the second release agent layer included in respective release sheets produced in examples and comparative examples are shown in Table 1. It is to be noted that, in the table, 1,4-polybutadiene is represented by “PB”, 1,2-polybutadiene is represented by “RB”, and polyisoprene is represented by “PI”.

### [Evaluation Method and Test Method]

### <Release Force at Ordinary State>

The release forces of the first release sheet and the second release sheet of each of the double-sided pressure-sensitive adhesive sheets produced in examples and comparative examples were measured. The release force of the first release sheet was measured in accordance with JIS-Z0237, by cutting the double-sided pressure-sensitive adhesive sheet into 20 mm wide by 200 mm long, and pulling the first release sheet, with the second release sheet being fixed, at a speed of 300 mm/min in a 180° direction by using a tensile tester. Further, the release force of the second release sheet was measured in accordance with JIS-Z0237, by cutting the double-sided pressure-sensitive adhesive sheet into 20 mm wide by 200 mm long, adhering the pressure-sensitive adhesive layer from which the first release sheet was released to the polyethylene terephthalate film (PET film) (trade name: “PET50T-100”, manufactured by Mitsubishi Polyester Film GmbH) to thereby fix the PET film, and pulling the second release sheet at a speed of 300 mm/min in a 180° direction.

Further, at the time of releasing the first release sheet, presence or absence of deformation of the pressure-sensitive adhesive layer, release failure, and the like was observed. In the case of “present”, the releasability was marked as “x”. In the case of “absent”, there was further observed, at the time of releasing the second release sheet, presence or absence of deformation of the pressure-sensitive adhesive layer, release failure, transfer failure of the pressure-sensitive adhesive layer to the adherend (PET film), and the like. In the case of “absent”, the releasability was marked as “∘”, and in the case of “present”, the releasability was marked as “x”.

### <Release Force After Thermal Acceleration>

The release forces each of the double-sided pressure-sensitive adhesive sheets produced in examples and comparative examples were measured in the same manner as in the test of release force at ordinary state, after the double-sided pressure-sensitive adhesive sheets being left standing under a temperature condition of 70° C. (thermostatic oven of 70° C.) for 168 hours and then under conditions of 23° C., 50% RH for 24 hours. The measurements were performed in the same manner as in the test described above.

### <Transferred Amount of Silicone Compounds>

Both pressure-sensitive adhesive surfaces of the pressure-sensitive adhesive layer, the pressure-sensitive adhesive layer being obtained by releasing the first release sheet and the second release sheet from the double-sided pressure-sensitive adhesive sheet, were each measured for a ratio of Si elements which are present thereon by using the following X-ray photoelectron spectrometer (measurement apparatus: “Quantera SXM” manufactured by ULVAC-PHI, Inc).

### <Measurement of Amount of Generated Gas>

The measurement was performed by: heating the pressure-sensitive adhesive layer from which the first release sheet and the second release sheet were released by Purge & Trap (a trade name: “JHS-100A”, manufactured by Nihon Denshi Kogyo, Inc.) at 120° C. for 10 minutes, thereby collecting the generated gas; introducing the gas into a GC-MS apparatus (a trade name: “Turbo Mass”, manufactured by Perkin Elmer, Inc.); and calculating the amount of the generated gas in terms of n-decane. It is to be noted that the amount in terms of n-decane was determined from an n-decane calibration curve prepared beforehand by regarding the detection intensity of the generated gas obtained by the GC-MS apparatus as the detection intensity of n-decane. The results thereof are collectively shown in Table 1.

TABLE 1

| | First release sheet | | | | Second release sheet | | | |
|---|---|---|---|---|---|---|---|---|
| | | | Release force | | | | Release force | |
| | | Compounding | [mN/20 mm] | | | Compounding | [mN/20 mm] | |
| | | ratio | | Thermal | | ratio | | Thermal |
| | Constituent | PB or | Ordinary | acceleration | Constituent | PB or | Ordinary | acceleration |
| | material | PI/RB | state X | X′ | material | PI/RB | state Y | Y′ |
| Example 1 | PB | — | 130 | 150 | PB + RB | 90/10 | 250 | 280 |
| Example 2 | PB | — | 130 | 150 | PB + RB | 85/15 | 300 | 340 |
| Example 3 | PB | — | 90 | 200 | PB + RB | 90/10 | 400 | 600 |
| Example 4 | PI | — | 200 | 300 | PI + RB | 90/10 | 450 | 500 |
| Example 5 | PB + RB | 98/2 | 150 | 180 | PB + RB | 85/15 | 300 | 400 |
| Comparative | Si | — | 60 | 60 | PB + RB | 90/10 | 250 | 280 |
| Example 1 | | | | | | | | |
| Comparative | PB + RB | 90/10 | 250 | 280 | PB + RB | 90/10 | 250 | 280 |
| Example 2 | | | | | | | | |
| Comparative | PB | — | 130 | 150 | PB | — | 130 | 150 |
| Example 3 | | | | | | | | |
| Comparative | PB | — | 130 | 150 | PB + RB | 50/50 | 2,900 | 3,000 |
| Example 4 | | | | | | | | |

| | Pressure-sensitive adhesive layer | | | | | | |
|---|---|---|---|---|---|---|---|
| | | Si transferred | | | | | |
| | | amount (% by atom) | | Amount | | | |
| | | First | Second | of | | | |
| | Pressure- | release | release | generated | | | |
| | sensitive | sheet | sheet | gas | Y − X | Y′ − X′ | |
| | adhesive | side | side | [μg/cm²] | [mN/20 mm] | [mN/20 mm] | Releasability |
| Example 1 | A | 0.0 | 0.0 | 0.05 | 120 | 130 | ∘ |
| Example 2 | A | 0.0 | 0.0 | 0.05 | 170 | 190 | ∘ |
| Example 3 | B | 0.0 | 0.0 | 0.31 | 310 | 400 | ∘ |
| Example 4 | A | 0.0 | 0.0 | 0.05 | 250 | 200 | ∘ |
| Example 5 | A | 0.0 | 0.0 | 0.05 | 150 | 220 | ∘ |
| Comparative | A | 2.0 | 0.0 | 0.05 | 190 | 220 | ∘ |
| Example 1 | | | | | | | |
| Comparative | A | 0.0 | 0.0 | 0.05 | 0 | 0 | x |
| Example 2 | | | | | | | |
| Comparative | A | 0.0 | 0.0 | 0.05 | 0 | 0 | x |
| Example 3 | | | | | | | |
| Comparative | A | 0.0 | 0.0 | 0.05 | 2,770 | 2,850 | x |
| Example 4 | | | | | | | |

As is apparent from Table 1, the double-sided pressure-sensitive adhesive sheet of the present invention was excellent in releasing performance. In contrast, satisfactory results could not be obtained from the double-sided pressure-sensitive adhesive sheets of the respective comparative examples. Further, the double-sided pressure-sensitive adhesive sheet of the present invention was free of a silicone compound, and thus is free from adverse affects on electronic parts such as relays.

What is claimed is:

1. A double-sided pressure-sensitive adhesive sheet comprising:
a pressure-sensitive adhesive layer;
a first release sheet having a first release agent layer adhered to one surface of the pressure-sensitive adhesive layer; and
a second release sheet having a second release agent layer adhered to another surface of the pressure-sensitive adhesive layer, wherein:
the first release agent layer and the second release agent layer are each formed by using a diene-based polymeric compound;
when, at ordinary temperatures, a release force of the first release sheet to the pressure-sensitive adhesive layer is represented by X and a release force of the second release sheet to the pressure-sensitive adhesive layer is represented by Y, a relationship of Y−X≧50 is satisfied and Y represents 2,000 or less, where units of X and Y are each mN/20 mm; and
the pressure-sensitive adhesive layer, the first release agent layer, and the second release agent layer are each substantially free of silicone compounds.

2. The double-sided pressure-sensitive adhesive sheet according to claim 1, wherein, when, after the double-sided pressure-sensitive adhesive sheet is left to stand for 168 hours under a 70° C. environment, a release force of the first release sheet to the pressure-sensitive adhesive layer is represented by X′ and a release force of the second release sheet to the pressure-sensitive adhesive layer is represented by Y′, a relationship of Y′−X′≧50 is satisfied and Y′ represents 2,000 or less, where units of X′ and Y′ are each mN/20 mm.

3. The double-sided pressure-sensitive adhesive sheet according to claim 1, wherein the first release agent layer and the second release agent layer each formed by using the diene-based polymeric compound are formed by curing with an active energy ray.

4. The double-sided pressure-sensitive adhesive sheet according to claim 1, wherein the diene-based polymeric compound comprises 1,4-polybutadiene; and the second release agent layer contains a heavy release agent.

5. The double-sided pressure-sensitive adhesive sheet according to claim 4, wherein the heavy release agent comprises 1,2-polybutadiene.

6. The double-sided pressure-sensitive adhesive sheet according to claim 1, wherein the pressure-sensitive adhesive layer generates a gas in an amount of 1.0 μg/cm² or less in terms of n-decane when heated at 120° C. for 10 minutes.

7. The double-sided pressure-sensitive adhesive sheet according to claim 1, wherein a resin component of the pressure-sensitive adhesive layer contains morpholine.

8. The double-sided pressure-sensitive adhesive sheet according to claim 1, wherein the first release agent layer and the second release agent layer each contain an antioxidant.

9. The double-sided pressure-sensitive adhesive sheet according to claim 1, which is used for an electronic part.

10. A production method for the double-sided pressure-sensitive adhesive sheet according to claim 1, comprising:
forming a coating film by coating a top of a second release sheet with a material for forming a pressure-sensitive adhesive layer, the material containing a pressure-sensitive adhesive;
forming the pressure-sensitive adhesive layer by drying the coating film; and
adhering a first release sheet to a surface of an opposite side of the formed pressure-sensitive adhesive layer to which the second release sheet is adhered.
